(19) United States
(12) Patent Application Publication
(10) Pub. No.: US 2004/0012593 A1
(43) Pub. Date: Jan. 22, 2004

(54) Generating animation data with constrained parameters

(76) Inventor: Robert Lanciault, Sante-Julie (CA)

Correspondence Address: HARNESS, DICKEY & PIERCE, P.L.C., P.O. BOX 828, BLOOMFIELD HILLS, MI, 48303, US

(21) Appl. No.: 10/197,238

(22) Filed: Jul. 17, 2002

(51) Int. Cl. G06T 15/70

(52) U.S. Cl. 345/473

(57) ABSTRACT

Animation data is produced in a data processing system having storage, a processing unit, a visual display unit (202) and input devices (203, 204). A simulated three-dimensional world-space is displayed to a user and an animatable actor is displayed in the world-space. Specifying input data is received from a user specifying desired locations and desired orientations of the actor in the world-space at selected positions along the time-line. First animation data is generated, preferably by a process of inverse kinematics. Animation of the actor is displayed in response to the generated first animation data. Parametric constraining data is received that selects an animation parametric constraint, such as the extent to which an actor's feet may slip. Defining data is received defining different values of parametric constrain at different identified positions along the time-line. The processor generates new constrained animation data in response to the defined values.

### BACKGROUND OF THE INVENTION

1. Field of the Invention

The present invention relates to generating animation data in which an animation solving procedure is constrained.

2. Description of the Related Art

Many techniques for the generation of animation data using data processing systems are known. Known data processing systems are provided with storage devices, a processing unit or units, a visual display unit and input devices configured to receive input data in response to manual operation. Computer systems of this type may be programmed to produce three-dimensional animations in which a simulated three-dimensional world-space is displayed to a user. Furthermore, an animatable actor may be provided within this space. In this way, the actor may perform complex animations in response to relatively simple input commands, given that the actor is defined in terms of its physical bio-mechanical model within the three-dimensional world-space.

Sometimes the procedure for generating animation data will introduce undesirable artefacts. Sometimes it is possible for an animator to remove these artefacts by manual intervention. However, this places an additional burden upon the animator and, in some environments, such an approach may not be possible. In order to alleviate the introduction of artefacts of this type, it is known to specify constraints upon the procedures being performed so as to ensure that a particular artefact does not occur. Thus, for example, if an undesirable motion or movement of the actor has been introduced it is possible to specify a constraint to the effect that a particular portion of the actor may not move in a particular way.

### BRIEF SUMMARY OF THE INVENTION

According to a first aspect of the present invention, there is provided a method of producing animation data in a data processing system, said system comprising data storage means, processing means, visual display means and manually responsive input means, comprising the steps of: displaying a simulated three-dimensional world-space to a user on said visual display means: displaying an animatable actor in said world-space: receiving specifying input data from a user via said manually responsive input means specifying desired locations and desired orientations of said actor in said world-space at selected positions along a time-line: instructing said processing means to generate a first animation data: displaying animation of said actor in response to said generated first animation data: receiving parametric constraining data selecting an animation parametric constraint: receiving defining data defining different values of said parametric constraint at different identified positions along said time-line: and instructing said processing means to generate constrained animation data in response to said defined values.

In this way a particular type of constraint is selected and defined by the receiving of parametric constraining data. Values for this selected parametric constraint are received so as to define values for the constraint during operation. In addition, different values of the parametric constraint are received for different identified positions along the time-line. Thus, in this way, in addition to specifying values for particular constraints, it is also possible for the values of these constraints to change, that is to be animated themselves, over the duration of the animation when animation data is being produced.

### BRIEF DESCRIPTION OF THE SEVERAL VIEWS OF THE DRAWINGS

FIG. 1 shows an environment for the production cinematic film or video material etc.

FIG. 2 shows procedures for the production of animation data.

FIG. 3 details a computer system for the production of animation data.

FIG. 4 identifies operations performed by the system shown in FIG. 3;

FIG. 5 details procedures identified in FIG. 4;

FIG. 6 details the visual display unit shown in FIG. 2;

FIG. 7 details procedures identified in FIG. 5;

FIG. 8 details the actor identified in FIG. 6;

FIG. 9 shows further operations of the actor illustrated in FIG. 8;

FIG. 10 illustrates movement of an actor's joints;

FIG. 11 illustrates an actor's hand;

FIG. 12 illustrates animation types;

FIG. 13 illustrates operations identified in FIG. 7;

FIG. 14 illustrates user selection;

FIG. 15 illustrates the reception of an identification of parametric constraint; and

FIG. 16 illustrates values of a parametric constraint that have been specified at different positions along the time-line.

### WRITTEN DESCRIPTION OF THE BEST MODE FOR CARRYING OUT THE INVENTION

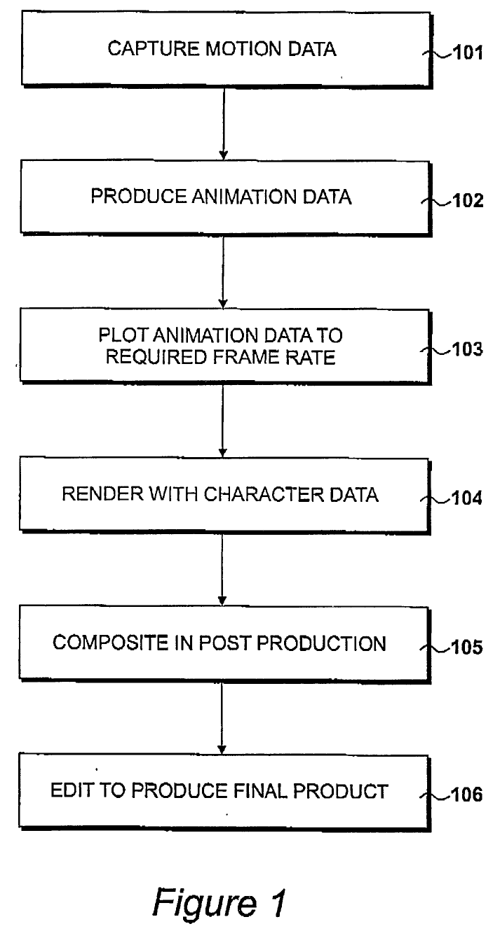

FIG. 1

An environment for the production of cinematographic film or video material for broadcast purposes is illustrated in FIG. 1, in which content data includes images produced using animation techniques.

The animation is to follow the characteristics of a humanoid character and should in the finished product appear as realistic as possible. A known technique for achieving this is to use motion capture in which detectors or sensors are applied to a physical person whose movements are then recorded while performing the desired positional movements of the animated character. Thus, at step 101 motion data is captured and at step 102 this motion data is supplied to a production facility for the production of animation data. At step 102, the motion data captured at step 101 is processed to generate animation data. This animation data is not in the form of an animated character. The animation data defines how the character is to move and essentially represents translations and rotational movements of the character's joints.

At step 103 the animation data is plotted on a frame-by-frame basis at whatever frame rate is required. Thus, for video productions, the output data may be plotted at thirty frames per second whereas for cinematographic film the data may be plotted at twenty-four frames per second. It is also known in high definition systems to invoke a higher frame rate when greater realism is required.

At step 104 the animation data is rendered in combination with character data in order to produce viewable output. Thereafter, in many applications and as shown at step 105, the character data is composited with other visual data within a post production facility. Thereafter the resulting “footage” maybe edited at step 106 to produce a final product.

It should be appreciated that the production of animation data as illustrated at step 102 maybe included in many production environments and the procedures illustrated in FIG. 1 or shown nearly as a single example of one of these.

The production and plotting of animation data essentially takes place within a three-dimensional environment. Thus, it is possible to make modifications to this data to ensure that it is consistent with constraints applied to a three-dimensional world-space. The rendering operation illustrated at step 104 involves taking a particular view within the three-dimensional world-space and producing two-dimensional images therefrom. Thereafter, within the compositing environment, a plurality of two-dimensional views may be combined to produce the finished result. However, it should be appreciated that once two-dimensional data of this type has been produced, the extent to which it may be modified is significantly limited compared to the possibilities available when modifying the three-dimensional animation data. Consequently, if artefacts are introduced during the production of the animation data that are not rectified while the data remains in its three-dimensional format, it then becomes very difficult to overcome such artefacts during the compositing stages. Thus, in some situations it may be necessary to revert back and produce the animation data again. Alternatively, the artefact will remain in the finished production or less attractive measures (such as masking) must be taken in order to mitigate the presence of the artefact.

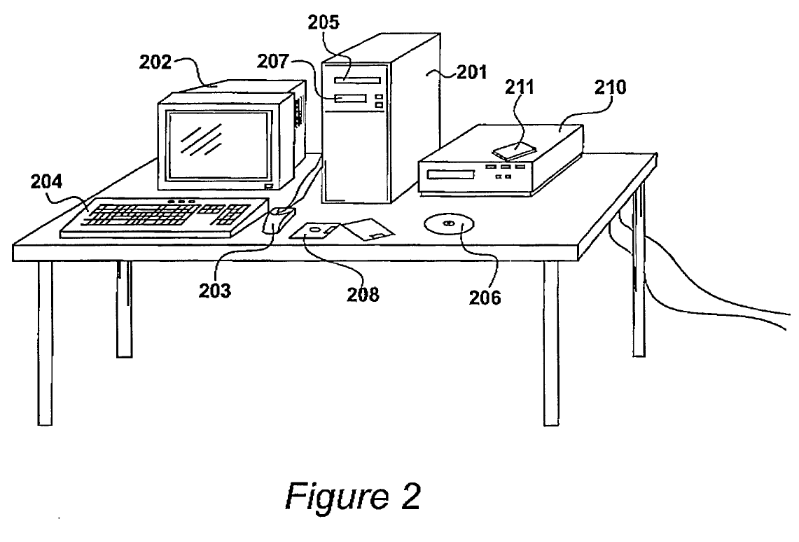

FIG. 2

Procedure 102 for the production of animation data is effected within an animation data production facility such as that illustrated in FIG. 2.

The animation data production facility includes a computer 201, a visual display unit 202 and manual input devices including a mouse 203 and a keyboard 204. Additional input devices could be included, such as stylus/touch tablet combinations or tracker balls etc. The programmable computer 201 is configured to execute program instructions read from memory. The computer system 201 includes a drive 205 for receiving CD ROMs such as ROM 206. In addition, a drive 207 is provided for receiving magnetic storage discs such as zip discs 208. Thus, animation data generated by the processing system 201 may be stored locally, written to removable storage media, such as zip discs 208, or distributed via a network. Animation data could also be stored on removable solid state storage devices, such as smart cards and flash cards etc.

Programs executed by computer system 201 are configured to display a simulated three-dimensional world-space to a user via the visual display unit 202. Within this world-space, one or more animatable actors may be shown and may be manipulated. Input data is received, possibly via mouse 203, to specify desired locations and orientations of the actor or actors within the three-dimensional world-space. Having orientations and positions defined manually by a user, the computer system includes instructions to generate smooth animation data such that the actor or actors are seen to animate over a pre-determined time-line. Thus, this allows smooth animation performances to be introduced and possibly combined with animation data derived from the motion capture process. Similarly, portions of the animation data derived via motion capture may be modified so as to obtain a desired result.

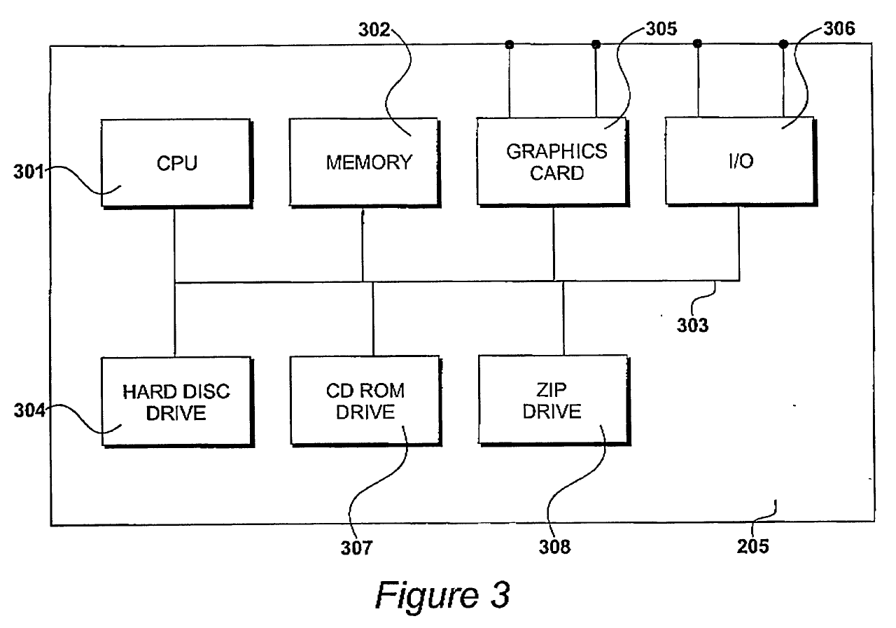

FIG. 3

Computer system 201 is detailed in FIG. 3 and includes an Intel based central processing unit 301 operating under instructions received from random access memory devices 302 via a system bus 303. The memory devices 303 provide at least one hundred and twenty-eight megabytes of randomly accessible memory and executable programs are loaded to this memory from the hard disc drive 304. Graphics card 305 is connected to the system bus 303 and supplies output graphical information to the visual display device 202. Input card 306 receives input data from the keyboard 204 and the mouse 203, and from any other input devices connected to the system. CD ROM drive 205 communicates with the processor 301 via an interface card 307 and, similarly, the zip drive 207 communicates via a zip drive interface 308.

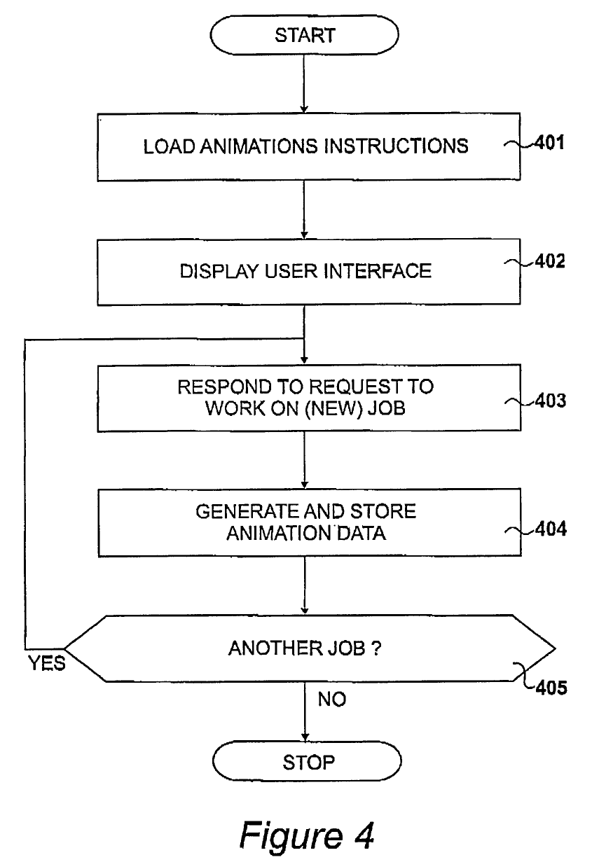

FIG. 4

Operations performed by the system shown in FIG. 3, when implementing a preferred embodiment of the present invention, are detailed in FIG. 4. At step 401 animation instructions are loaded and at step 402 a user interface is displayed to a user.

At step 403 the system responds to a request to work on a job, which may involve loading previously created data so as to complete a job or may involve initiating a new job.

At step 404 animation data is generated and stored until an operator decides whether the session should close.

At step 405 a question is asked as to whether another job is to be considered and when answered in the affirmative control is returned to step 403. Alternatively, the question asked at step 405 is answered in the negative, resulting in the procedure being terminated.

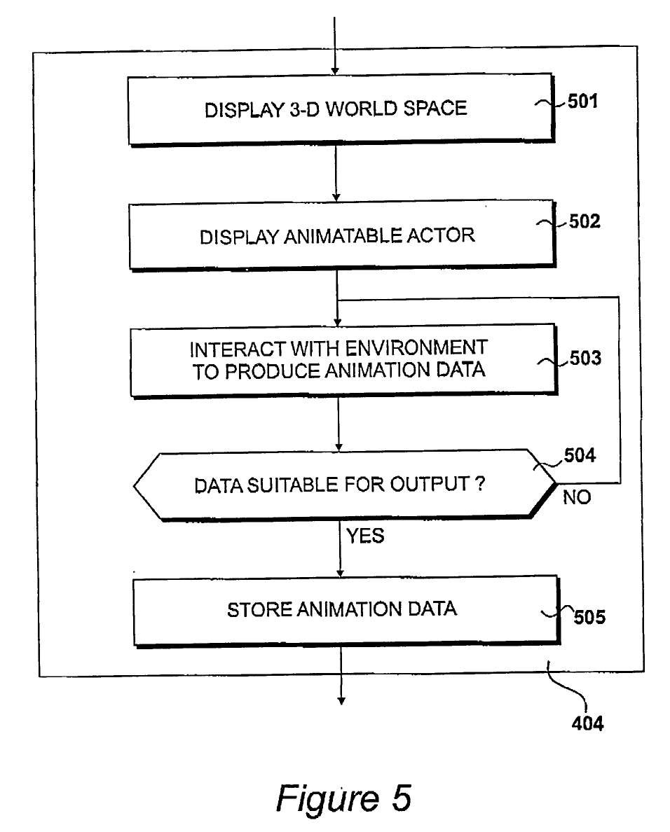

FIG. 5

Procedures for the generation and storing of animation data identified in FIG. 4 are detailed in FIG. 5. At step 501 a three-dimensional world-space is displayed to a user whereafter at step 502 an animatable actor is displayed. At step 503 the user interacts with the displayed environment to produce animation data. Thereafter, at step 504 a question is asked as to whether data suitable for output has been produced and if this question is answered in the negative control is returned to step 503 allowing the user to make further modifications. If the data is considered suitable for output, the data is stored as animation data at step 505.

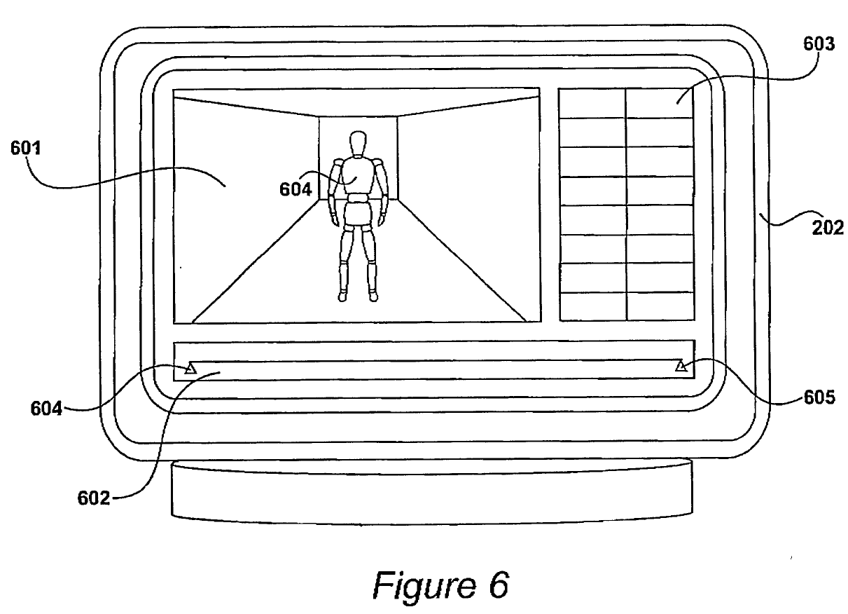

FIG. 6

Visual display unit 202 is shown in FIG. 6. The display unit displays a graphical user inter-face to a user that includes a viewing window 601, a time-line 602 and a menu area 603. The viewing window 601 displays the three-dimensional world-space as produced by step 501. In addition, the viewing window also displays an animatable actor 604 as generated by step 502. User interaction with the environment shown in FIG. 6, as identified at step 503, involves a user generating input data so as to interact with the viewing window, the time-line 602 or the menu 603. Thus, for example, a user may identify particular locations on the displayed actor 604 in order to enforce particular positions and orientations. Similarly, the user may identify particular positions on the time-line displayed in window 602 in order to specify that a particular orientation and location in the three-dimensional world-space is to be defined for a particular temporal position defined along the time-line. Further interactions are completed by manual operation of displayed buttons within the menu area 603. The menus are also nested to the effect that many selections will result in a display of further menus allowing more refine selections to be defined by the user.

The preferred embodiment allows for the production of animation data in a data processing system, possibly but not necessarily of the type illustrated in FIG. 2. The system has data storage, processing devices, visual display devices and manually responsive input devices. A three-dimensional world-space is displayed to the user such as that shown at 601 in FIG. 6. In addition, an animatable actor 604 is also displayed within the world-space. In a preferred embodiment, specifying input data is received from a user via the manually responsive input devices specifying desired locations and orientations of the actor 604 in the world-space 601 at selected positions along the time-line 602. As used herein, an actor location refers to the actors absolute position within the world-space environment. At this location, the actor may adopt many body configurations and a particular configuration of the body parts is referred to herein as an orientation.

Being an animation, different orientations and locations are adopted at different positions in time. These positions in time are identified by making appropriate selections along the time-line 602. Thus, the time-line represents the duration of the animation. Furthermore, key positions along the time-line may be defined such that the actor is constrained at these key positions (in time) so as to ensure that the actor performs the tasks required and, furthermore, to ensure that during the compositing process the actor will interact correctly with other elements within the finished product. As shown in FIG. 6, the time-line is a linear line running from the start of the animation to the end of the animation. However, it should be appreciated that many other types of graphical user inter-face could be adopted in order to allow a position in time to be selected.

The processing system is instructed to generate animation data so as to complete the animation in regions that have not been specified by key positions. Procedures for generating animation data within a three-dimensional environment are usually referred to as animation solvers. Many different types of solvers are known and typical solvers within the environment disclosed by the preferred embodiment involved known techniques such as forward kinematics and inverse kinematics. In this way, complex, sophisticated and realistic animation data sets are produced that require relatively minimal input from a user or animator. In this way, the amount of time and effort required in order to generate animation data is significantly reduced, thereby widening the application techniques and allowing relatively unskilled operators to produce acceptable results.

After animation data has been produced by a selected solver, the animation of the actor is displayed so as to allow an operator to view the finished results. The present preferred embodiment allows a user to select an animation parametric constraint that places a constraint upon the animation data. In the preferred embodiment, an animation constraint is made via menu 603, whereafter a user is presented with an appropriate interface to allow the definition of different values for the parametric constraint, at different identified positions along the time-line. Thus, having identified a particular parametric constraint a user would specify values for the constraint and specify positions in time at which these values are to be adopted. Thus, in the preferred embodiment, it is possible to identify different values for the parametric constraint at different positions along the time-line. Thus, although the constraints do not form part of the animation data itself, these parametric constraints may themselves effectively be animated thereby changing their effect upon the animation data at different positions along the time-line. Such a procedure may be adopted in order to reduce or eliminate artefacts while mitigating the introduction of new artefacts due to the constraint itself. Furthermore, the ability to animate these constraints over the time-line also allows new artistic effects to be introduced. Thus, although in many applications an activity performed by an actor may be considered to be an artefact, in some situations it may be possible to re-introduce the artefact in order to produce an artistic result with minimal additional effort.

Thus, after the parametric values have been defined, the processing device is instructed to generate constrained animation data which may or may not produce the result desired by the operator.

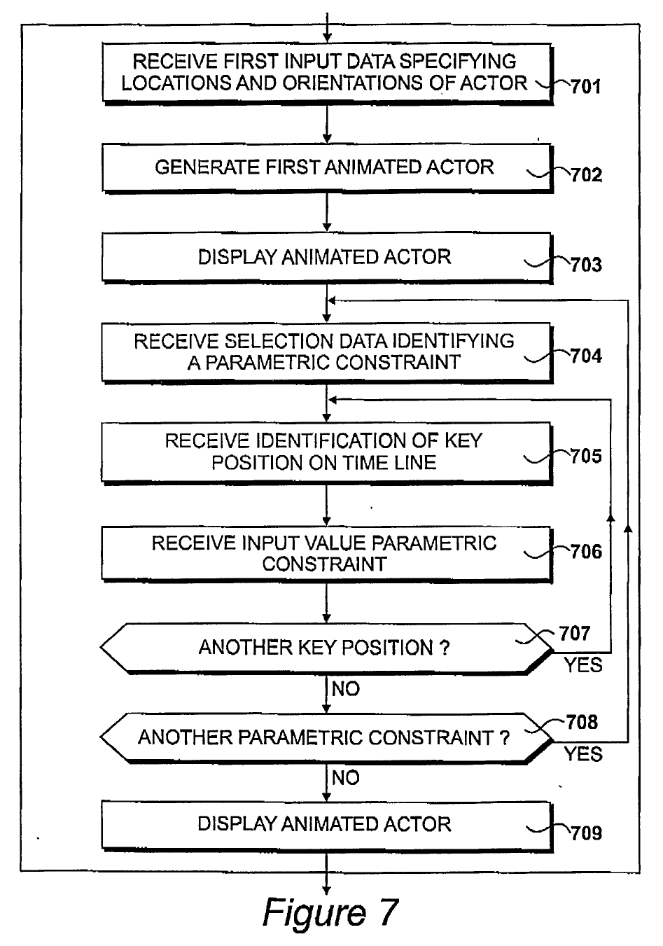

FIG. 7

Procedures 503 for allowing interaction by a user with the environment displayed for the production of animation data is detailed in FIG. 7. At step 701 first input data is received that specifies locations and orientations of an actor. At step 702 first animation data is generated in response to the locations and orientations specified at step 701.

At step 703 an actor, animated in response to the first animation data generated at step 702, is displayed within the viewing window 601 of FIG. 6. Having viewed the animated actor, a user is now in a position to make modifications to the animation data. In the preferred embodiment, these modifications are introduced by defining different values for the parametric constraints at different positions along the time-line.

At step 704 selection data is received identifying a parametric constraint. At step 705 an identification of a key position is received on the time-line. Thereafter, at step 706 an input value for the parametric constraint is received. Thus, to summarise, step 704 involves the identification of a particular parametric constraint to be invoked. At step 705 a position in time is identified at which the parametric constraint takes effect. Thereafter, at step 706 the actual definition of the parametric constraint is received.

At step 707 a question is asked as to whether another key position is to be defined and when answered in the affirmative control is returned to step 705. If no further key positions for the constraint under consideration are to be defined the question asked at step 707 is answered in the negative whereafter control is directed to step 708. At step 708 a question is asked as to whether another parametric constraint is to be considered and when this question is answered in the affirmative, control is returned to step 704. If no further parametric constraints are to be specified, the question asked at step 708 is answered in the negative whereafter at step 709 the animated actor is again displayed to the user.

In the preferred embodiment, as described above, key positions in time are identified before values are supplied for the parametric constraint. However, it should be appreciated that the process could be performed in different orders in order to achieve the same result. Thus, it is equivalent to receiving a full definition of the parametric constraint before a position on the time-line is defined.

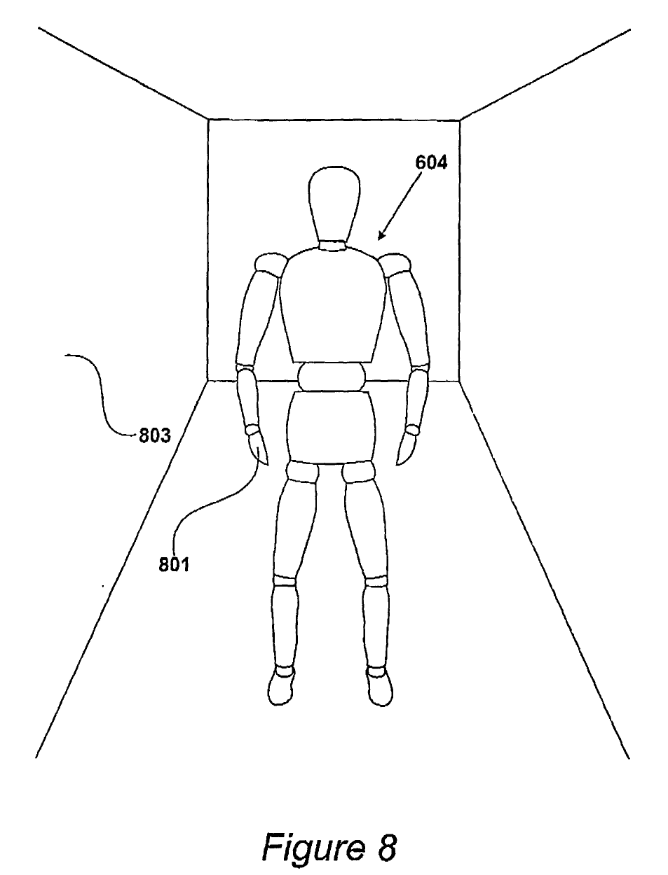

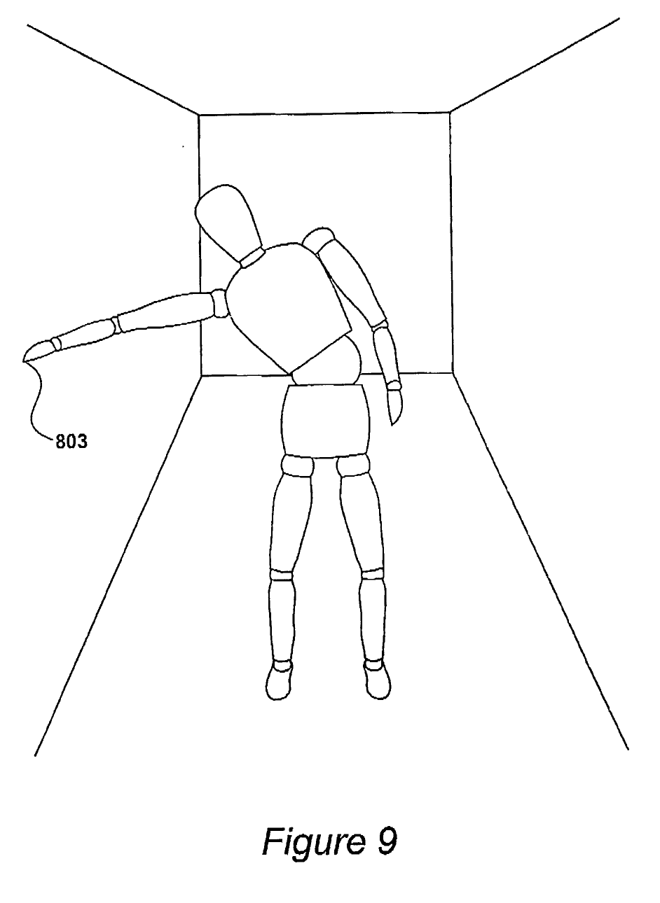

FIG. 8/FIG. 9

Actor 604 is detailed in FIG. 8. The orientation of the actor shown in FIG. 8 represents its default starting orientation in which all of the joints have rotation values set at their central extent. A user specifies a simple animation in this example in which the right hand 801 of the actor is pulled so as to touch a wall at a position 803. The resulting orientation is illustrated in FIG. 9. Thus, in this simple example, a time-line is defined representing the duration of the animation. At the start of the time-line the actor 604 adopts an orientation as illustrated in FIG. 8. At the end of the time-line the actor 604 is required to have an orientation as illustrated in FIG. 9. The animation solver, implemented by procedures performed by the central processing unit 301, generates animation data for the duration of the animation such that, for any position on the time-line, specific orientations for the actor may be deduced.

The user has specified a linear motion of an actor body part without making any reference to the permitted movements of the actor's bio-mechanical model. Animation data, defining specific functional movements of the actor's joints are derived, in the preferred embodiment, by a process of inverse kinematics.

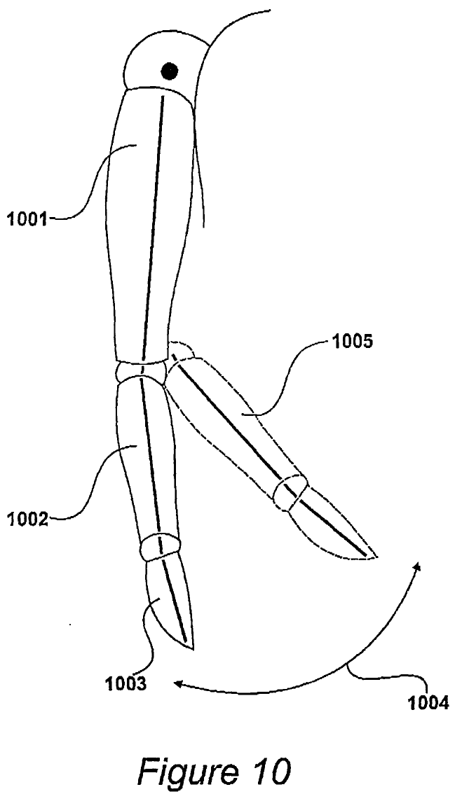

FIG. 10

Movement of an actor's joint is illustrated in FIG. 10. In this example, an arm is defined as having three components taking the form of an upper arm 1001, a lower arm 1002 and a hand 1003. In this example, the upper arm 1001 remains stationary and the lower arm rotates at the elbow joint through an angle illustrated by arrow 1004. Thus, at the end of the animation, the lower arm has moved to a position identified as 1005. Animation data is generated representing the degree of angle 1004 for any particular position of the animation. Thus, over the duration of the animation, the extent of angle 1004 for the elbow joint may be plotted as a function against time. Thus, having derived this function, for any temporal position along the time-line, it is possible to derive the extent of the joint's rotation. Thus, when joint rotations are considered for all of the joints that make up the bio-mechanical model of the actor, the full orientation of the actor may be derived for any position along the time-line.

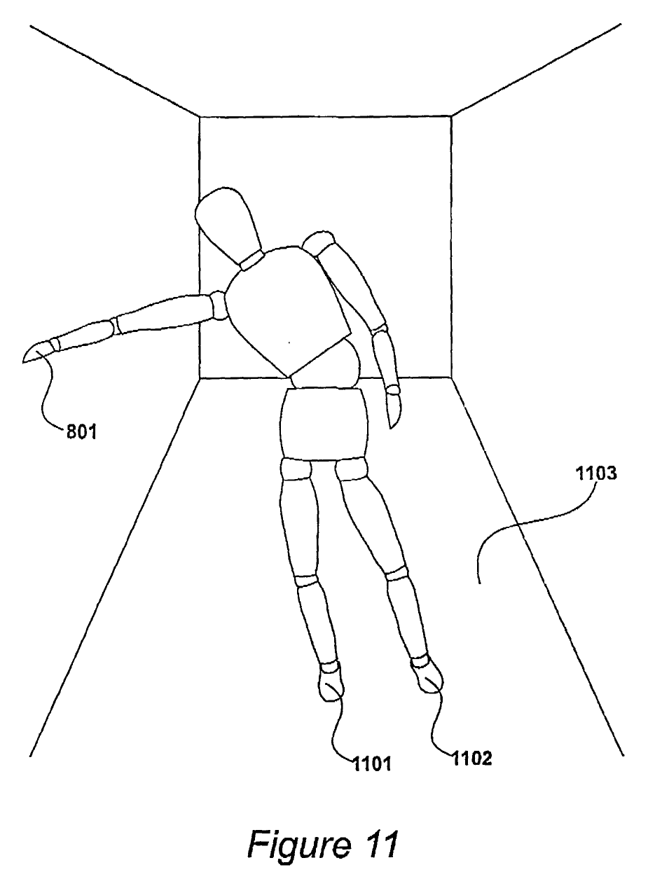

FIG. 11

In this illustrative example, the actor's hand 801 has been moved from the orientation shown in FIG. 8 to the orientation shown in FIG. 9. Animation data has been generated such that, over the duration of the time-line, the actor is seen to move smoothly from its orientation shown in FIG. 8 to its orientation shown in FIG. 9. However, due to the nature of the animation data generating procedures, an artefact has been introduced, as illustrated in FIG. 11. In addition to the actor's hand 801 coming into contact with the wall, the animation procedures have resulted in the actor's feet 1101 and 1102 remaining in contact with a floor 1103 but sliding sideways. Within its mathematical constraints, the movement of the actor appears smooth and lifelike. However, the particular motion produced by the animation would only be realistic were the actor to be standing on a slippery surface.

Within the overall production of the animation, the presence of a slippery surface may be correct and the animation may have produced a desired result. However, it is also possible that this has effectively introduced an artefact. Within the three-dimensional world-space displayed to the user, the presence of the artefact may appear relatively minimal. However, if the animation data is subsequently rendered with character information and then composited against background data, it is possible that the artefact may become considerably more irritating than was first suspected. Efforts would then be required to disguise the artefact during the compositing process or, alternatively it would be necessary for the animation procedures to be performed again.

However, in an alternative scenario, it is possible that an animator is required to produce the effect of an actor slipping on a slippery surface. The production of new animation data consistent with the introduction of the slippery surface could be quite difficult to achieve. However, by being provided with a parametric constraint that changes feet slipping values over time, it may be possible to introduce a desired feet slipping activity with relatively minimal effort.

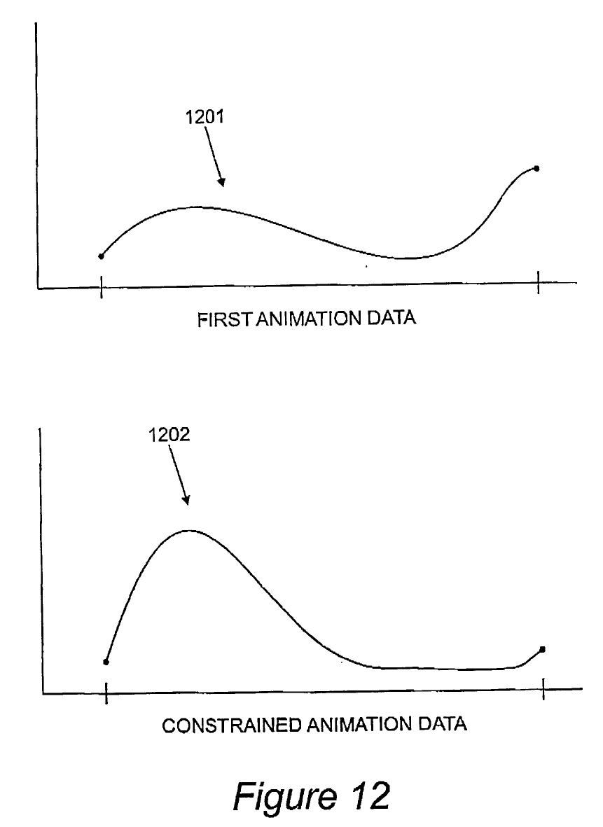

FIG. 12

Animation data may be produced without the inclusion of any parametric constraints. This results in an output animation data set in which, over the duration of the animation, functional descriptions are made for the movement of the actor's joints. The inclusion of a parametric constraint will not increase the amount of data in the subsequent animation data set. However, in order to invoke the constraint defined one or many of the functional descriptions change. Thus, both output data sets may be valid but the first may include an artefact and the second may have a constraint applied thereto in order to remove the artefact. Alternatively, a first data set may show normal movement of the actor whereas a second data set, having a parametric constraint defined, introduces new and possibly artistic movements to the actor, such as the slipping of the feet.

Changes to animation data sets are illustrated in FIG. 12. An unconstrained first animation data is illustrated at 1201. Similarly, constrained animation data is illustrated at 1202. The shape of the animation function differs for the particular joint under consideration. Taken in combination, the actor achieves the animation specified but for the first no additional constraint is applied whereas for the second an additional parametric constraint constrains the nature of the animation in order to take account of additional limitations or requirements.

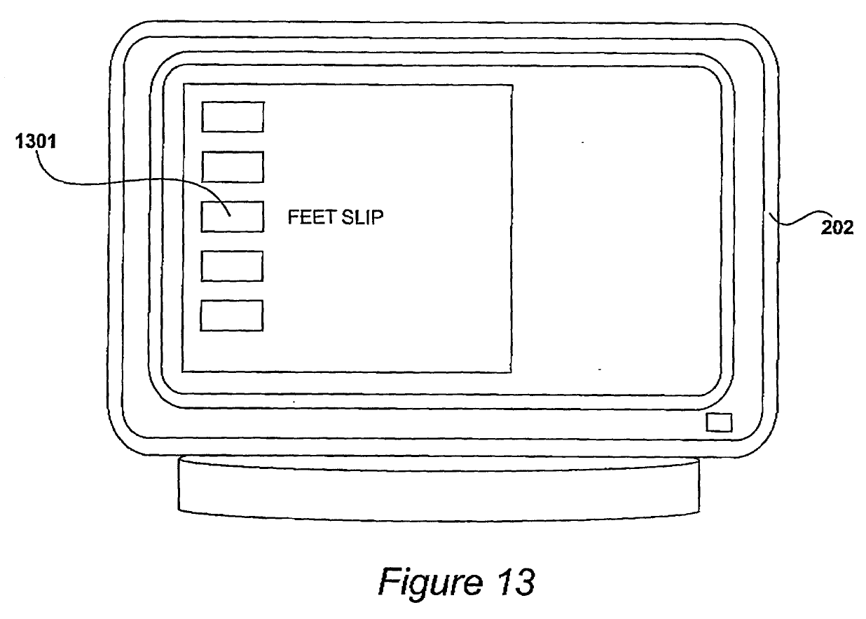

FIG. 13

Step 704 involves the reception of selection data identifying a parametric constraint. Using an input device such as mouse 203, a user identifies a particular selection within menu 603 specifying that a parametric constraint is to be applied. After making this selection from menu 603, a further menu is displayed as illustrated in FIG. 13. This identifies many constraints for which parameters may be specified and then animated over time. In this example, the feet slip constraint 1301 is selected.

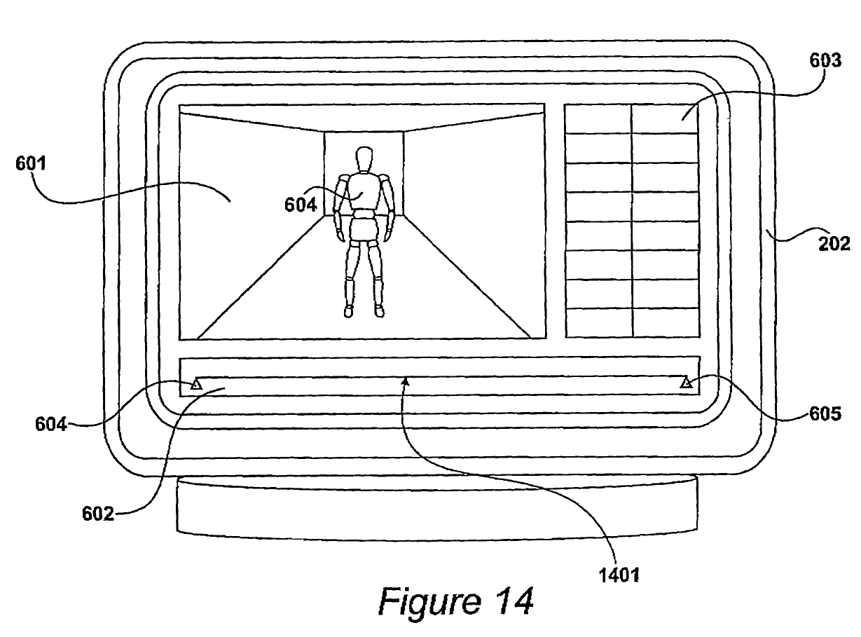

FIG. 14

Having made a selection to the effect that the feet slip constraint is to be modified parametrically, the user is then invited to identify a position on time-line 602 at which the parameter value is to be defined. Key positions are identified by triangles 604 and 605, these represent the start of the time-line and the end of the time-line. As shown in FIG. 14, a new key position triangle has been introduced, namely 1401, showing that a constraint has been applied to the animation at the particular position of item 1401 on the time-line 602, as required by step 705. After completing step 705, resulting in a position being identified as shown in FIG. 14, a definition of the parametric constraint is received at step 706.

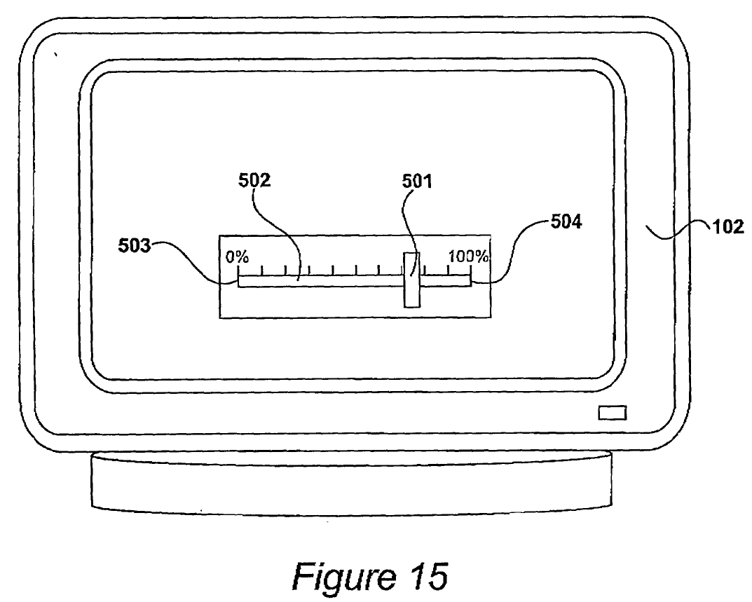

FIG. 15

The reception of the definition of the parametric constraint is made by a user inter-face being displayed to the user of the type illustrated in FIG. 15. Thus, for the selected parametric constraint, the user is invited to define a specific value. Using an input device such as the mouse 203, a user selects a slider 1501. Having selected slider 1501, the user may move the slider over a range as illustrated by line 1502. At its left extreme 1503 the parametric constraint is set to zero percent and as such has no effect. At its right extreme 1504 the parametric constraint is set to one hundred percent and therefore the constraint is fully enforced. Between these extremes, the degree to which the constraint is invoked varies linearly from having no effect to having a full effect.

Thus, at specified positions along the time-line, different constraints may be invoked and the degree to which these constraints are invoked is also controlled.

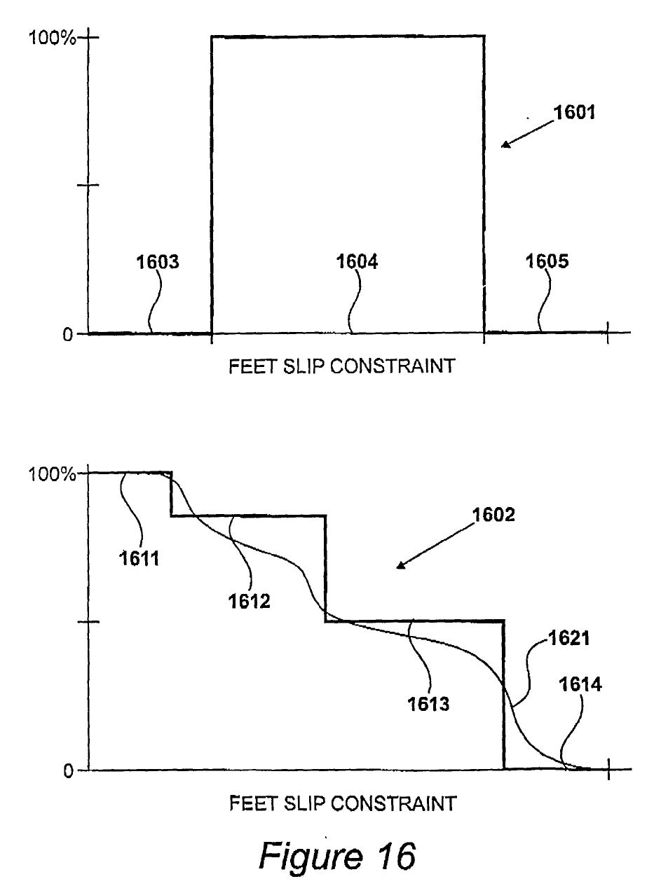

FIG. 16

A first graph 1601 and a second graph 1602 shown in FIG. 16 illustrate how a parametric constraint may be changed over the duration of an animation. In this example, both constraints refer to the feet slipping operation although it should be appreciated that many other constraints may have parametric values recorded in a similar fashion.

In the example illustrated by graph 1601 there is an initial period 1603 during which the feet-slip constraint is set to a value of zero. Thereafter, there is a central portion 1604 where the feet-slip constraint is set fully to one hundred percent. Thereafter, there is an end portion 1605 where the feet-slip constraint is returned to its zero value. This parametric definition maybe invoked to prevent the artefact of the feet slipping as described with respect to FIGS. 9 and 11. The constraint is invoked over portion 1604 where it is required in order to prevent the feet slipping as illustrated in FIG. 11. Elsewhere, the feet-slipping constraint is not introduced unnecessarily given that it is possible that it could introduce further artefacts.

The previously described alternative use of the parametric constraint is illustrated by graph 1602. In this example, feet-slipping is introduced as an artistic procedure, where it provides a simple mechanism for introducing what could be a relatively difficult animation to produce.

At portion 1611 the feet-slip constraint has a value of one hundred percent and is therefore fully enforced. Thereafter, over portion 1612 the feet-slip constraint is reduced to a value of eighty percent therefore some slipping will be allowed. Thereafter, over portion 1613 the feet-slipping constraint is reduced to a value of fifty percent whereupon a significant amount of slipping is allowed. This is then followed by portion 1614 in which the feet-slip constraint has been reduced to zero percent. In this example, feet-slipping is considered desirable such that the character is perceived to start slipping over portion 1612, experience greater slipping over portion 1613 and then experience extreme slipping over portion 1614: to the extent the character could be seen to fall over.

In the first embodiment transitions of parametric values occur abruptly in response to key positions being defined. Alternatively, after defining key positions, a process may smooth out the transition response of using spline curves etc as illustrated by curve 1621.

What we claims is:

1. A method of producing animation data in a data processing system, said system comprising data storage means, processing means, visual display means and manually responsive input means, comprising the steps of:
displaying a simulated three-dimensional world-space to a user on said visual display means;
displaying an animatable actor in said world-space;
receiving specifying input data from a user via said manually responsive input means specifying desired locations and desired orientations of said actor in said world-space at selected positions along a time-line;
instructing said processing means to generate first animation data;
displaying animation of said actor in response to said generated first animation data;
receiving parametric constraining data selecting an animation parametric constraint;
receiving defining data defining different values of said parametric constraint at different identified positions along said time-line; and
instructing said processing means to generate constrained animation data in response to said defined values.

2. A method of producing animation data according to claim 1, wherein instructions for said processing means to generate first animation data cause said processing means to perform inverse kinematics operations.

3. A method according to claim 1, wherein said parametric constraining data is received via a graphical user interface.

4. A method according to claim 3, wherein said graphical user interface includes a slider control.

5. A method according to claim 1, wherein said constrained parameter relates to the feet slipping attribute of the actor.

6. A computer-readable medium having computer-readable instruction executable by a computer such that when executing said instructions a computer will perform the steps of:
displaying a simulated three-dimensional world-space to a user;
displaying an animatable actor in said displayed world-space;
responding to specifying input data from a user specifying desired locations and desired orientations of said actor in said world-space at selected positions along a time-line;
generating first animation data;
displaying animation of said actor in response to said generated first animation data;
receiving parametric constraining data selecting an animation parametric constraint;
receiving defining data defining different values of said parametric constraint at different identified positions along said time-line; and
generating constrained animation data in response to said defined values.

7. A computer-readable medium having computer-readable instructions according to claim 6, such that when executing said instructions a computer will produce first animation data by a process of inverse kinematics.

8. A computer-readable medium having computer-readable instructions according to claim 6, such that when executing said instructions a computer will present a graphical user interface to a user to facilitate the reception of parametric constraining data.

9. A computer-readable medium having computer-readable instructions according to claim 8, such that when executing said instructions a computer will present a graphical user interface to a user that includes a slider control.

10. A computer-readable medium having computer-readable instructions according to claim 6, wherein said constrained parameter relates to the feet slipping property of the actor.
